(19) United States
(12) Patent Application Publication
(10) Pub. No.: US 2003/0065745 A1
(43) Pub. Date: Apr. 3, 2003

(54) Method of transmitting network material to handheld devices

(76) Inventors: Lawrence V. Wolfe, New Ringgold, PA (US); Walter James Ludlow, Fogelsville, PA (US)

Correspondence Address: Ratner & Prestia, PO Box 980, Valley Forge, PA, 19312, US

(21) Appl. No.: 09/968,208

(22) Filed: Oct. 1, 2001

(51) Int. Cl. G06F 15/16; H04M 1/00; H04B 7/00; H04B 1/38

(52) U.S. Cl. 709/219; 455/554; 370/310

(57) ABSTRACT

The present invention is a method of providing information to the user of a global computer network comprising the steps of: (a) marking pieces of material from a computer readable page; (b) receiving from a handheld device a request for information from the computer readable page; (c) extracting the marked pieces of material from the computer readable page; and (d) transmitting the marked pieces of material to the handheld device.

### FIELD OF INVENTION

The present invention relates to global computer networks and more specifically to the transmission of material on the computer network to handheld devices.

### BACKGROUND OF INVENTION

Many businesses today advertise and conduct business via a global computer network. A typical and very popular computer network is the Internet, within which is contained the World Wide Web (www). The information available through these types of computer networks is as vast as the people who use it.

Typically, the Internet and other such global computer networks are accessed through a personal computer, either a desktop version or laptop computer. Increasing popularity in handheld devices such as cellular phones and handheld digital assistants has created demand for technology that allows the interfacing of these devices with the known global computer networks. These hand held devices, however, often transmit and receive information without wires. These devices typically communicate using satellite and telephonic These devices typically communicate using satellite and telephonic communication technologies. User demand for the accessibility of the known global computer networks with these handheld devices is, therefore, growing.

Typically, businesses and information suppliers who use the Internet have web sites that allow an interface between the web site owner and the user. These computer readable pages provide information and interaction between the owner and the user. In such a case, it is common that the web site owner employs an Internet Service Provider (ISP) to supply the technological requirements, such as a server, needed to present the interface and allow communication between the user and the web site owner.

The web sites and other computer readable pages accessible through today's global computer networks are often elaborate and complicated, with eye-catching graphics. Typically, the text of the page requires substantially less memory than the remaining parts. The text, however, is often the most important information in which a handheld device user might be interested.

Because many of today's handheld devices are small and otherwise not well suited to receive large amounts of graphics and audio information, web site owners typically want to provide just the text portion of their sites to the users of these handheld devices. In addition, graphical navigational hyperlinks normally do not render functionally when displayed on a handheld device. In such a case, however, modifications must be made on the web site provider's end. The magnitude of these modifications often necessitates the development of a completely separate web site, designed and maintained by the owner in conjunction with the owner's primary, more elaborate web site.

Prior art methods for providing information from a web site to a handheld device typically involved the creation of redundant web sites for various handheld devices.

These modifications add extra expense and additional work as updates to the sites must be made multiple times with separate programming involved for each handheld device type. An improved method of providing information to handheld devices, would, therefore, overcome the need for the maintenance of multiple sites at the owner's server (or ISP).

### SUMMARY OF THE INVENTION

The present invention is a method of providing handheld information to the user of a global or local computer network. The method requires, as a starting point, selecting an existing computer readable page, typically a web site, and identifying which part of that web site information the owner of the website wishes to make available to the user of a handheld device. The method comprises the steps of identifying those pieces of material from an existing computer readable page, then marking, or “tagging,” the identified pieces of material from the computer readable page. This marking, or tagging, is done either directly in the source code itself or by utilizing certain webs site development tools to do it graphically. These web site development tools are generally known to those skilled in the art. Thus, the same code is used to support both the traditional web site, viewable from a conventional personal computer or other suitable device, and also to support data transmission to a handheld device that generally cannot handle all of the graphics and additional material on a typical web site. The method continues when the invention operator receives, from a handheld device, a request for information from the computer readable page. The invention operator's server then receives the web page content from the web site owner's ISP, extracts the marked pieces of material from the computer readable page, and transmits the marked pieces of material to the handheld device.

In one exemplary embodiment of the present invention, the method further comprises the steps of determining what type of handheld device is requesting the information and transmitting the marked pieces of material in a form specifically suitable for display on the particular handheld device.

### BRIEF DESCRIPTION OF THE FIGURES

FIG. 1 is a schematic representation of the components used in the method of the present invention;

FIG. 2 is an example of code used in a computer readable page without tagging shown;

FIG. 3 is an example of code used in a computer readable page with tagging shown in accordance with one embodiment of the present invention;

FIG. 4 is an example of a computer readable page as displayed on a typical desktop or laptop computer; and

FIG. 5 is an example of marked material displayed on a handheld device in accordance with the present invention.

### DETAILED DESCRIPTION OF THE INVENTION

The present invention provides a method for using existing web sites and other such computer readable pages accessible via a global computer network to efficiently provide selective information from those web sites to handheld devices such as Internet-ready cellular phones, personal digital assistants, and other related handheld devices. Specifically, the present invention relates to the format of material for handheld wireless devices. In addition, the present invention provides such previously mentioned content in a form that it may be audibly accessed via standard telephones.

The invention is a method of providing existing web site material to a handheld device without having to independently create a separate source of material. The method includes the step of taking existing web site content and selectively marking, or tagging, parts of that web site code. The marked code is that material (usually, but not necessarily, text) which the owner wishes to make available to the handheld device user. Only the selected marked material is made available to the handheld device, obviating the need to transmit unnecessary and voluminous data which would only increase transmission time and which is usually too excessive to be efficiently downloaded and displayed on the handheld device.

More specifically, the method allows for the interpretation of existing HTML documents into a mobile-ready format without reprogramming and without having to create a separate site or data source. By recognizing special embedded codes in the existing web site code, the invention operator's software extracts from the conventional web site only the data that has been selected for transmission to mobile devices, as opposed to all content which would be available to a typical portal, such as a personal computer.

The current invention works by allowing the owner of a particular web site to select which pieces of its existing web pages (typically the text portions, but not necessarily) the owner wishes to make available to the handheld device user. The web site owner must agree ahead of time to participate in the method, and usually does so through its existing ISP. Once a decision is made by the web site owner that it wants certain information from its web site to be available to handheld devices, the owner identifies which material should be available. In one embodiment, a code tag is placed around each such body of text embedded within the existing content, that the owner desires to make available. This code tag marks the information that the web site owner has determined is appropriate for display on the user's handheld device. It is also possible to render functionally usable graphic hyperlinks on any handheld device. When a user of the web site attempts to access the site with a handheld device, that request passes through a server managed by the operator of the current invention before reaching the ISP who hosts the web site owner's site. In a related but different embodiment, the owner might identify that information which it specifically wishes to prevent from being sent to the handheld device.

As the user's request passes through the invention operator's server, information is collected about the type of handheld device through which the user has made his request. The operator's server then communicates with the ISP who hosts the particular web site. The content of the particular web site is then brought from the ISP to the operator's server where the marked information is extracted. Only this marked information is then sent to the handheld device user. Once extracted from the full web site code at the invention operator's server, the marked content is then delivered to the handheld device in a format compatible with the particular device, be it an Internet-ready cellular phone, handheld personal digital assistant, or other handheld device. The invention operator's server recognizes the different handheld device protocols from the information contained in the particular device's request. The invention operator's server is capable of recognizing the type of requesting device and then formatting the response in the appropriate protocol.

One advantage to this invention is that the web site owner only needs to maintain one web site. Any changes to the site can be made at one time, keeping all information current without the need to modify a separate site for handheld devices. After the tags are in place, the substantive information can be changed and any user of the site will see those updates, whether the user is using a handheld device or wired desktop computer. Moreover, no separate changes need to be made to a separate database for handheld users.

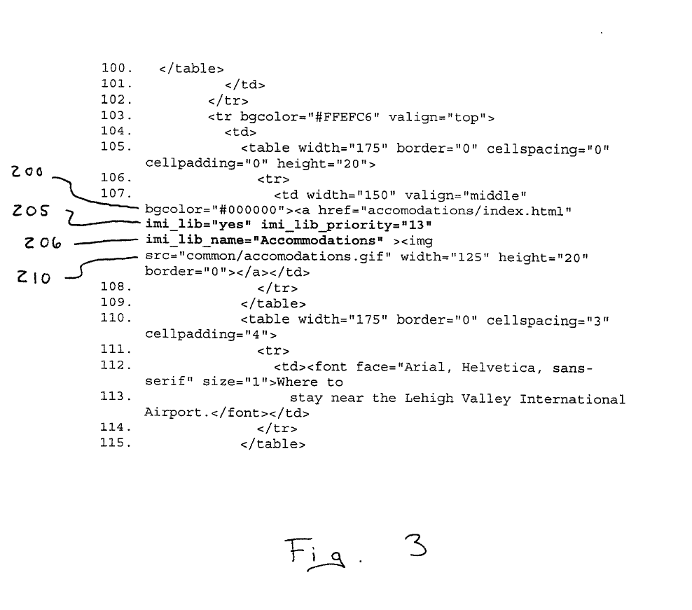

Typically, a tag is placed around a body of code. FIG. 3 (discussed in greater detail below) shows an example of code that has been partially marked in accordance with the present invention. In this case, “imi_lib=” has been added within the HTML code. This tag indicates to the operator server's software that these are lines of text that should be extracted and delivered to the user's handheld device.

Such “imi_lib=” tags, which are only recognizable by the software used in the invention operator's server, determine which content will be rendered, excluded, or converted from a graphical hyperlink to a text hyperlink for rendering on a handheld device. The invention operator's software consists of certain lines of code that could be written in various computer languages. Such code can reside either on the invention operator's server, the web site owner's server, or the web site owner's ISP server.

Means for delivering the marked material to the handheld device are well known to those skilled in the art. These include the use of existing Internet networks, phone lines, and satellites. The ways in which the different components of this invention communicate are not specific or critical to the invention. One skilled in the art would know the different means available to allow the communications between elements.

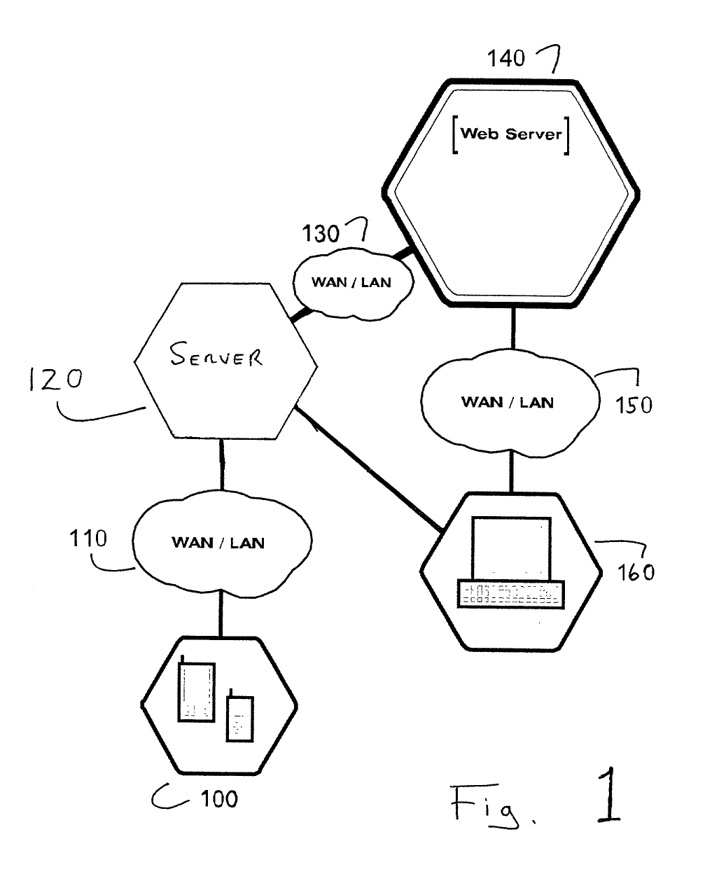

FIG. 1 shows, schematically, the arrangement of the invention operator's server with respect to existing, known components of Internet service. Typically, a handheld device 100 requests information via either a Wide Area Network (WAN) 110 or a Local Area Network (LAN) 110, either of which then directs the request to invention operator's server 120. Invention operator's server 120 is operated by the invention operator and contains the software that, among other things, recognizes the tags as discussed above. Invention operator's server 120 then directs the request via higher level WAN 130 or higher level LAN 130 to upper level server 140 which contains the web site owner's previously marked, or tagged, web site content. Upon receipt of the request, upper level server 140 sends the marked, or tagged, web site content via upper level WAN 130 or upper level LAN 130 back to invention operator's server 120 where its is appropriately converted and functionally rendered on the requesting handheld device 100 via lower level WAN 110 or lower level LAN 110. In one embodiment, upper level server 140 may also send the same content via alternate WAN 150 or alternate LAN 150 to a conventional wired device 160, such as desktop or laptop computer.

Where a wired device, such as a desktop personal computer is calling for information through the invention operator's server 120, the web site is transmitted from upper level server 140 to invention operator's server 120 but the tags are ignored. In such a case, the full content of the web site is passed to the wired device 160. Where the invention operator server 120 knows the requesting device is a handheld device, however, the tags are invoked and only that material is extracted and passed to the handheld device 100.

Part of the overall method includes getting web site owners interested and involved with the invention. Some of the positive benefits of practicing the invention include the increased number of visitors that web site owners are able to attract to their sites. In addition, increased traffic is encouraged by allowing web site content to be accessed any place that a wireless signal can be accessed, instead of just on traditional wired computer hookups. In order to increase user visitation, without the traditional concomitant increase in work on the part of the web site owner, the web site owner agrees to take advantage of the invention. At that time, the owner selects which material it desires to make available to the user of a handheld device. That material is then marked in accordance with the present invention, as discussed more fully below.

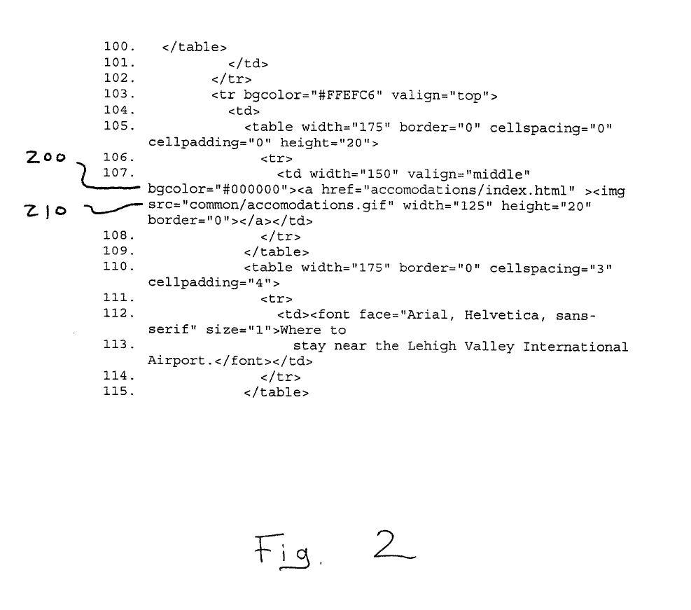

FIG. 2 shows an example of a piece of code for a typical web page. FIG. 3 shows the same code marked, or tagged, according to the present invention. In FIG. 2, code line 200 ends with “><img” and is followed by code line 210. In FIG. 3, however, code line 200 is interrupted before “><img” with tags according to the present invention. In FIG. 3, code line 200 is separated from its end and code line 210 by the addition of two lines of tagging, code lines 205 and 206, which contain the markers identifying that this information should be presented to a handheld device where a handheld device is requesting the web site content.

Moreover, FIGS. 2 and 3 represent the same substantive lines of code where FIG. 3 has been tagged for rendering on a handheld device and FIG. 2 has not been so tagged. Looking closely at FIG. 3, code line 200 represents a graphical hyperlink that will be presented in textual form to the user of the website using a handheld device. Importantly, however, this hyperlink, when presented in a more graphical form, such as a button, requires additional data and memory as compared to a mere textual hyperlink. Thus, in accordance with the present invention, code lines 205 and 206 are added, beginning with “imi_lib=” which identifies, for example, the “Accommodations” hyperlink as one which the web site owner wishes to make available, in textual form only, to the user of a handheld device. Without such code, the web sites would not be navigable with handheld devices.

The information contained at the “Accommodations” web page is the same for the user of either a wired or handheld device, with the exception of changes caused by yet additional markings or taggings in accordance with this invention. In other words, through placement of the “imi_lib=” markers or tags (which is only one particular embodiment of how to mark or identify the code), the web site owner is able to again select which additional information will go to the handheld device versus all of the information that would go to a typical wired device.

In the discussion above, the tag, “imi_lib=” was the particular marker used to indicate the material which should be extracted. One skilled in the art could envision any number of equivalent markers. The important aspect of the marker or tag is that it triggers the software in the operator's server to extract the particular information from the web site and transmit only that information to the handheld device.

### EXAMPLE

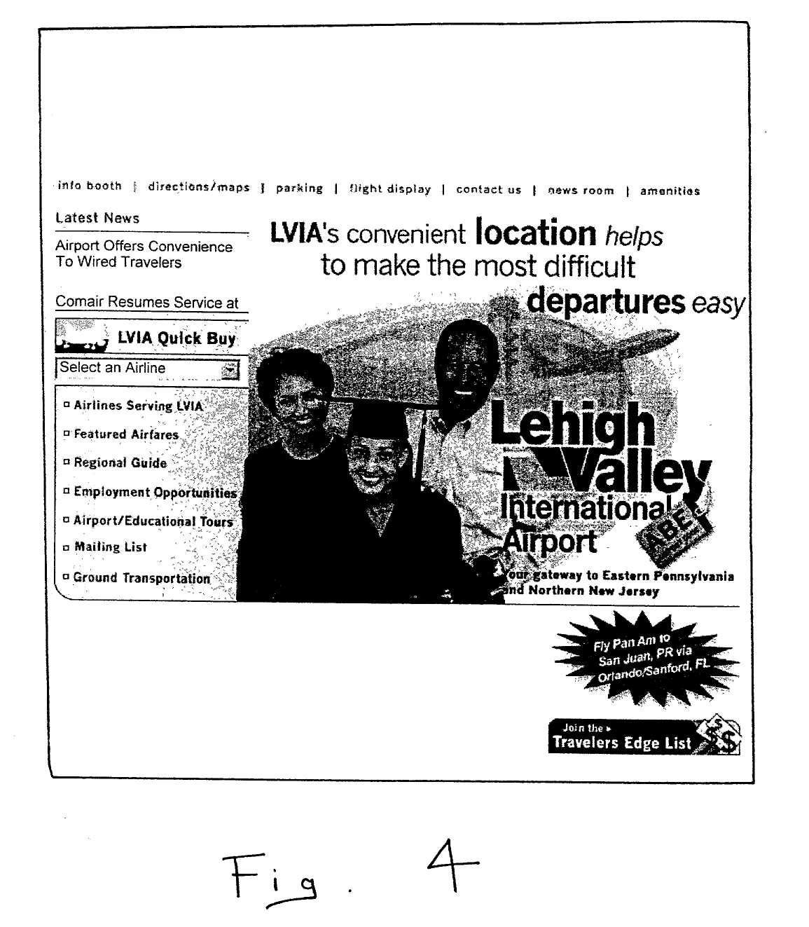

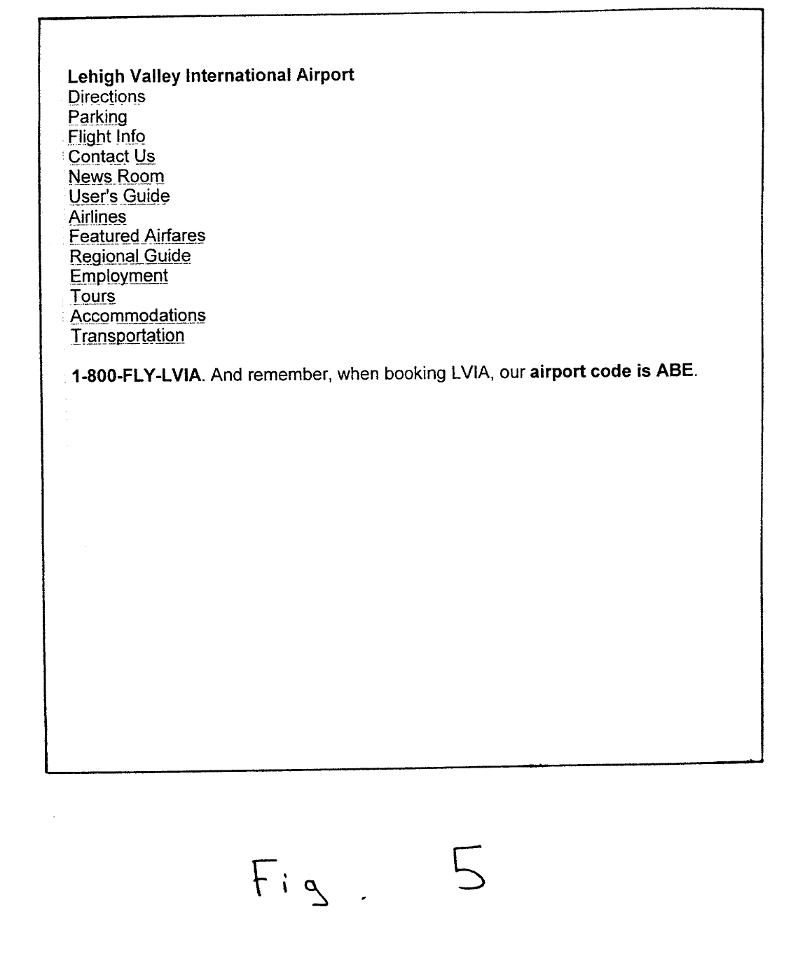

FIG. 4 is a schematic representation of a typical web site. FIG. 5 shows the textual information that is displayed when a handheld device user requests information from the same web site as that shown in FIG. 4. That which is shown in FIG. 4 includes graphical, often colored, visual material. This is what the user of a wired device such as a desktop or laptop computer would see when he enters the web site address, www.lvia.org. When a user of a handheld device wishes to obtain information from the same web site owner, the user would enter a modified web site address, such as wireless.lvia.org. The modified web site address can be entered by any known means, such as through a keypad, voice activation, or other means.

This second address is not a second site, but it triggers the invention operator's server to extract only the marked, or tagged, material and forward that. Moreover, the request indicates that the invention operator's server should obtain the web site material from the requested site, extract the tagged or otherwise identified text, and send that text to the handheld device user. The handheld device user would then see what is shown in FIG. 5, which is the textual, tagged material of the web site shown in FIG. 4.

The present invention has been set forth with regard to several preferred embodiments, but the full scope of the invention should be ascertained by the claims that follow.

1. A method of providing information to the user of a global computer network comprising the steps of:
(a) marking pieces of material from a computer readable page;
(b) receiving from a handheld device a request for information from said computer readable page;
(c) extracting said marked pieces of material from said computer readable page; and
(d) transmitting said marked pieces of material to said handheld device.

2. The method of claim 1 further comprising the steps of determining what type of handheld device is requesting said information and transmitting said marked pieces of material in a form particularly suitable for display on said handheld device.

3. The method of claim 1 further comprising the step of contacting an existing server to provide said computer readable page between steps (c) and (d).

4. The method of claim 1, wherein said step of marking pieces of material includes adding identifiable characters to the existing code comprising said material.

5. The method of claim 1, wherein said marked pieces of material are first identified by the owner of said computer readable page and then marked.

6. The method of claim 1, wherein said marked pieces of material comprise all of the text from the computer readable page.

7. The method of claim 1, wherein said request for information made by said handheld device is received from a WAN.

8. The method of claim 1, wherein said request for information made by said handheld device is received from a LAN.

9. A method of providing information to the user of a global computer network comprising the steps of:
(a) identifying pieces of material from an existing computer readable page, wherein said computer readable page is viewable to a user of a computer network;
(b) marking said identified pieces of material from said computer readable page;
(c) receiving from a handheld device a request for information from said computer readable page;
(d) contacting an existing server to provide said computer readable page;
(e) receiving from said existing server said computer readable page;
(f) extracting said marked pieces of material from said computer readable page; and
(g) transmitting said marked pieces of material to said handheld device.

10. The method of claim 9 further comprising the steps of determining what type of handheld device is requesting said information and transmitting said marked pieces of material in a form particularly suitable for display on said handheld device.

11. The method of claim 9, wherein said step of marking pieces of material includes adding identifiable characters to the existing code comprising said material.

12. The method of claim 9, wherein said marked pieces of material are first identified by the owner of said computer readable page and then marked.

13. The method of claim 9, wherein said marked pieces of material comprise all of the text from the computer readable page.

14. The method of claim 9, wherein said request for information made by said handheld device is received from a wireless server.

15. A method of providing information to the user of a global computer network comprising the steps of:
(a) marking pieces of material from a computer readable page, said computer readable page hosted by a first server;
(b) receiving on a second server a request from a handheld device for information from said computer readable page;
(c) contacting said first server and obtaining from said first server said computer readable page;
(d) extracting said marked pieces of material from said computer readable page; and
(e) transmitting said marked pieces of material from said second server to said handheld device.
